(19) United States
(12) Patent Application Publication
(10) Pub. No.: US 2010/0070873 A1
(43) Pub. Date: Mar. 18, 2010

(54) Image display device, server, mobile terminal, image display method, and system

(75) Inventor: Mamoru Tokashiki, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/583,802

(22) Filed: Aug. 26, 2009

(30) Foreign Application Priority Data
Sep. 4, 2008 (JP) P2008-226696

(51) Int. Cl. G06F 3/01; G06F 15/16

(52) U.S. Cl. 715/745; 709/219; 455/566

(57) ABSTRACT

The image display device includes a content control section for making a display screen display image content, a terminal information acquisition section for acquiring terminal information sent by a mobile terminal, a user information storage section in which user information indicating an attribute of a user of the mobile terminal is stored, and a terminal information control section for making the display screen display the terminal information acquired by the terminal information acquisition section, based on the user information of the mobile terminal that sent the terminal information. Thereby, an image display device, a server, a mobile terminal, an image display method, and a system that enable more effective information sharing among a specific group can be provided.

### CROSS-REFERENCE TO RELATED APPLICATION

The present application claims priority from Japanese Patent Application No. JP 2008-226696 filed in the Japanese Patent Office on Sep. 4, 2008, the entire content of which is incorporated herein by reference.

### BACKGROUND OF THE INVENTION

1. Field of the Invention

The present invention relates to an information display device, a server, a mobile terminal, an image display method, and a system.

2. Description of the Related Art

In recent years, various electronic devices are becoming widespread in various places such as homes and offices. Along with digitalization of these electronic devices, there is a technical trend to share information among a plurality of electronic devices. For the information sharing, for example, emails and message boards are being used through computers and mobile phones now owned by almost every person.

### SUMMARY OF THE INVENTION

The computers and mobile phones are devices for personal use, and, for example, to share information among a specific group, such as family or office, each person has to check the emails or message boards by using the computer or the mobile phone. Accordingly, although information relating to a family, for example, can be shared, it is difficult to state positively that the information is effectively shared among a specific unit of group such as a family.

On the other hand, more and more homes own an image display device such as a television, and the television is becoming more digitalized. The television has a controller and buttons for channel selection or the like. However, the controller and buttons are not suitable for inputting information such as letters. Also, to separately connect an input device such as a keyboard, the input device has to be supplied, and a connection mechanism for connecting the input device has to be provided, thereby increasing the manufacture cost.

It is desirable to provide an image display device, a server, a mobile terminal, an image display method, and a system that enable more effective information sharing among a specific group

According to a first embodiment of the present invention, there is provided an image display device including: a content control section for making a display screen display image content; a terminal information acquisition section for acquiring terminal information sent by a mobile terminal; a user information storage section in which user information indicating an attribute of a user of the mobile terminal is stored; and a terminal information control section for making the display screen display the terminal information acquired by the terminal information acquisition section, based on the user information of the mobile terminal that sent the terminal information.

According to this configuration, image content is displayed on a display screen by a control by the content control section. On the other hand, terminal information sent by the mobile terminal is acquired by the terminal information acquisition section. Also, the terminal information is displayed on the display screen by a control by the terminal information control section based on the user information of the mobile terminal that sent the terminal information. Accordingly, not only image content, but also terminal information to be displayed based on user information can be provided to a user using the image display device.

Furthermore, when the terminal information acquisition section acquires a plurality of pieces of terminal information sent from one mobile terminal of the user, the terminal information control section may make the display screen display the plurality of pieces of terminal information in association with each other based on the user information stored in the user information storage section.

Furthermore, when the terminal information acquisition section acquires new terminal information from the mobile terminal that sent the terminal information already displayed by the display screen, the terminal information control section may make the display screen display the new terminal information additionally to the already displayed terminal information.

Furthermore, the terminal information may include at least one of text information inputted to the mobile terminal by the user, location information indicating a location of the mobile terminal and terminal content stored in the mobile terminal, and the terminal information control section may make the display screen display at least one of the text information, the location information and the terminal content.

Furthermore, where the location information is included in the terminal information acquired by the terminal information acquisition section, the terminal information control section may make the display screen display a map showing the location information.

Furthermore, when the terminal information acquisition section acquired a plurality of pieces of location information sent from one mobile terminal of the user, the terminal information control section may make the display screen display one map showing the plurality of pieces of location information.

Furthermore, the terminal information control section may make the display screen display the terminal information along with the image content displayed by a control by the content control section.

According to a second embodiment of the present invention, there is provided a server including: a terminal information control section for acquiring terminal information sent by a mobile terminal and storing the terminal information in a terminal information storage section; a user information control section for acquiring user information indicating an attribute of a user of the mobile terminal from a user information storage section of an image display device for displaying image content on a display screen; and a provision information control section for sending to the mobile terminal, when the terminal information control section acquires the terminal information, provision information to be provided to the user of the mobile terminal that sent the terminal information, based on the terminal information and the user information.

According to a third embodiment of the present invention, there is provided a mobile terminal including: a terminal information control section for sending terminal information to be displayed by a display screen of an image display device for displaying image content on the display screen; and a display control section for acquiring and making the display screen display provision information to be provided to a user sent from a server based on the terminal information sent by the terminal information control section and user information, indicating an attribute of the user that sent the terminal information, stored in the image display device.

According to a fourth embodiment of the present invention, there is provided an image display method including the steps of: making a display screen display image content; acquiring terminal information sent by a mobile terminal; and making the display screen display the terminal information acquired in the step of acquiring terminal information, based on user information indicating an attribute of a user of the mobile terminal that sent the terminal information.

According to a fifth embodiment of the present invention, there is provided a system including: a mobile terminal; a server in which terminal information sent by the mobile terminal is stored; and an image display device for displaying image content on a display screen; where the image display device includes a terminal information acquisition section for acquiring the terminal information from the server, a user information storage section in which user information indicating an attribute of a user of the mobile terminal is stored, and a terminal information control section for making the display screen display the terminal information acquired by the terminal information acquisition section, based on the user information of the mobile terminal that sent the terminal information.

According to the embodiment of the present invention, information can be more effectively shared among a specific group.

### BRIEF DESCRIPTION OF THE DRAWINGS

FIG. 1 is an explanatory diagram for describing an outline of a system according to an embodiment of the present invention;

FIG. 2 is an explanatory diagram for describing a mobile terminal according to the present embodiment;

FIG. 3 is an explanatory diagram showing an example of an image that the mobile terminal according to the present embodiment makes a display screen display;

FIG. 4 is an explanatory diagram for describing a server according to the present embodiment;

FIG. 5 is an explanatory diagram for describing an image display device according to the present embodiment;

FIG. 6 is an explanatory diagram showing an example of an image to be displayed on a display screen by the image display device according to the present embodiment;

FIG. 7 is an explanatory diagram showing an example of the image to be displayed on the display screen by the image display device according to the present embodiment;

FIG. 8 is an explanatory diagram showing an example of the image to be displayed on the display screen by the image display device according to the present embodiment;

FIG. 9 is an explanatory diagram showing an example of the image to be displayed on the display screen by the image display device according to the present embodiment;

FIG. 10 is an explanatory diagram showing an example of the image to be displayed on the display screen by the image display device according to the present embodiment; and

FIG. 11 is an explanatory diagram for describing an operation of the image display device according to the present embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### Outline of Embodiment

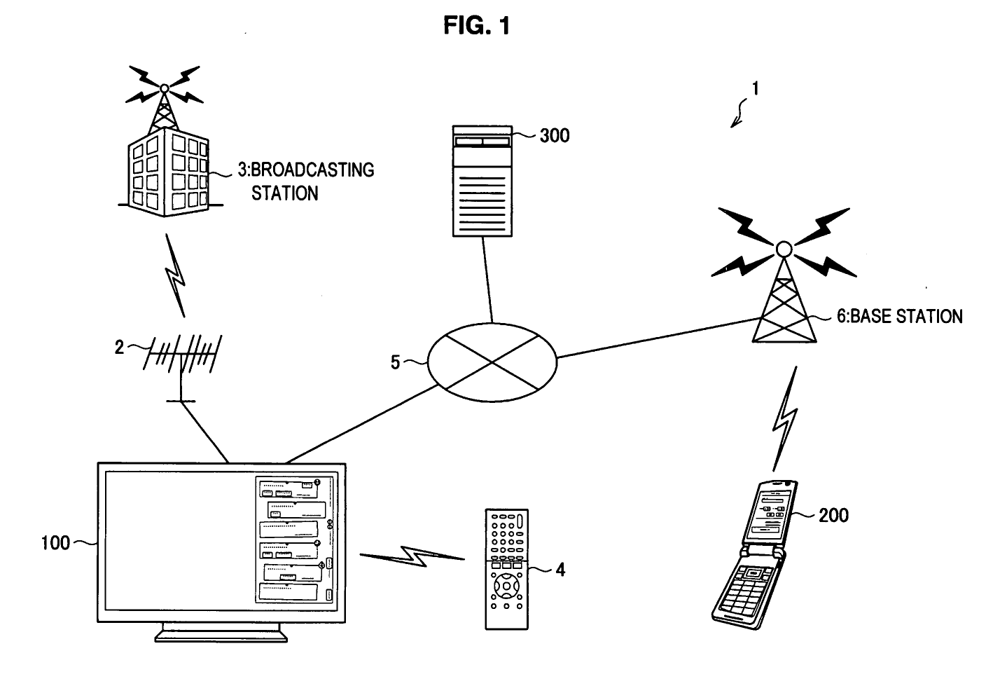

First, with reference to FIG. 1, an outline of a system according to an embodiment of the present invention is described. FIG. 1 is an explanatory diagram for describing the outline of the system according to the present embodiment.

As shown in FIG. 1, a system 1 according to the present embodiment mainly includes an image display device 100, a mobile terminal 200, and a server 300.

The image display device 100 receives, by a reception device (for example, an antenna 2), “image content” broadcasted and transmitted by a broadcasting station 3, and displays the image content. The image content means an image of a program, an image of a commercial or the like broadcasted by the broadcasting station 3, and includes not only a moving image, but also a still image, and further includes audio. Moreover, for the sake of convenience of explanation, the image content to be displayed by the image display device 100 here is described to be provided by broadcasting. However, the image display device 100 according to the present embodiment can also display, for example, image content broadcasted by cable, image content stored on a predetermined storage medium and played back by a playback device, or image content played back by a game machine or an information processing apparatus.

Furthermore, the image content to be transmitted from the broadcasting station 3 includes “attribute information” or the like. The attribute information is information indicating an attribute of image content. The attribute of image content includes, for example, the type (genre) of the image content, summary of the substance or the like, information relating to the cast or the producer, the broadcast time slot or the broadcast channel, the target viewers of the image content, information to be provided to the viewer in relation to the image content, or the like. The attribute information may be an electronic program guide (EPG), for example.

The image display device 100 may be, for example, a cathode ray tube (CRT), a liquid crystal display (LCD), a plasma display panel (PDP), a field emission display (FED), an organic electroluminescence display (organic EL, OLED), a video projector, or the like.

The image display device 100 operates in accordance with a predetermined signal sent from a predetermined operation panel with buttons arranged thereon, a remote control 4 with operation buttons arranged thereon or the like. In the following, explanation will be made for a case where the remote control 4 wirelessly sends (for example, infrared radiation) a predetermined operation signal according to an operation by a user and the image display device 100 acquires the operation signal and performs a predetermined operation.

The mobile terminal 200 is a terminal that can be owned by a user. The mobile terminal 200 is preferably one or more terminals owned by a user who may use the image display device 100, or by each of the user who uses the image display device 100 and a user in a predetermined relationship with the user who uses the image display device 100. That is, the mobile terminal 200 is a terminal owned by each user, and is preferably basically for the personal use of the user. On the other hand, as described above, the mobile terminal 200 is owned by a user who may use the image display device 100, or by the user who uses the image display device 100 and a user in a predetermined relationship with the user who uses the image display device 100. Here, the predetermined “relationship” between the user who uses the image display device 100 and a user owning the mobile terminal 200 means a relationship in a predetermined group such as a family, relatives, an office, an organization, a department, friends, or the like. Of course, the user of the image display device 100 is not limited to a user in such groups. However, it is preferable that the image display device 100 is mainly used by a user belonging to such a group, and that the user owns the mobile terminal 200. Furthermore, explanation will be made here for a case where every user in a group owns his/her own mobile terminal 200. However, it is needless to say that it is sufficient that one or more users in the group own the mobile terminal 200.

The mobile terminal 200 has a function of communicating with at least the server 300. The communication function may be a wireless communication or a wired communication. The mobile terminal 200 may be various devices such as a mobile phone, a laptop personal computer, a personal digital assistant (PDA), a portable music or image playback device, an image capturing device, a moving image shooting device, or the like. For the sake of convenience of explanation, a case will be described in the following where the mobile terminal 200 is a mobile phone. In a case the mobile terminal 200 is other portable device, each device will communicate with at least the server 300 by its own communication function. Here, since the mobile terminal 200 is a mobile phone, by using a call function or a data transmission/reception function of the mobile phone, wireless communication is performed with a base station 6, and communication is performed with the server 300.

The server 300 is configured, for example, to be able to communicate with the image display device 100 and the mobile terminal 200 via a network 5 such as the Internet, a local area network (LAN) or the like. In the present embodiment, terminal information or the like sent from the mobile terminal 200 is accumulated in the server 300, and the image display device 100 may acquire the terminal information from the server 300 and display the terminal information in relation to the user who sent the terminal information. Moreover, the server 300 will be described in detail in the following.

### Each Configuration Element of Embodiment

Heretofore, the outline of a system according to an embodiment of the present invention has been described.

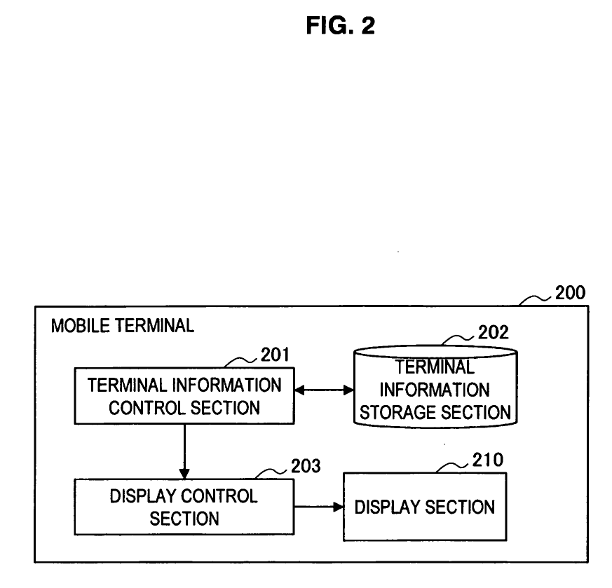

Next, with reference to FIGS. 2 to 10, each configuration element will be described in greater detail. Moreover, in the following, explanation will be made for the mobile terminal 200, the server 300, and the image display device 100 in this order.

### (Mobile Terminal 200)

FIG. 2 is an explanatory diagram for describing the mobile terminal 200 according to an embodiment of the present invention.

As shown in FIG. 2, the mobile terminal 200 includes a terminal information control section 201, a terminal information storage section 202, a display control section 203, and a display section 210.

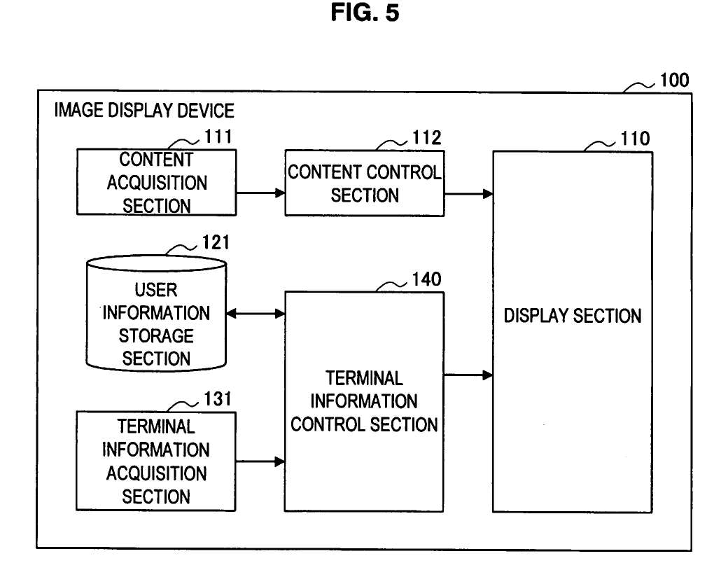

The terminal information control section 201 sends to the server 300 terminal information to be displayed on a display section 110 (see FIG. 5) of the image display device 100. The “terminal information (hereinafter also referred to as “message”)” is, as described above, information to be displayed on the display section 110 of the image display device 100, and mainly includes transmission information, identification (ID) information, text information, and terminal content.

The “transmission information” is information indicating the situation the mobile terminal 200 is placed in at the time of sending a message. The transmission information includes, for example, time information at which the message is sent, location information, or the like. Moreover, for example, when the mobile terminal 200 has a global positioning system (GPS) function, the location information may be location information specified by the GPS function. Furthermore, for example, when the mobile terminal 200 does not have the GPS function, the location information may be location information of the base station 6 used at the time of the message transmission. Moreover, the location information is determined to be added or not to be added according to an operation of the mobile terminal 200 by a user, and does not necessarily have to be included in the transmission information. Furthermore, for example, the terminal information control section 201 may specify the time information and the location information at the time of sending a message, and add to the message the specified information as the transmission information. Furthermore, for example, the base station 6 may specify the time information and the location information at the time of receiving a message in a similar manner, and add to the message the specified information as the transmission information.

The “ID information” is identification information for specifying the mobile terminal 200 which sent a message, and an ID number of the mobile terminal 200 may be used, for example. The ID number may be newly provided identification information, or existing identification information may also be used as the ID number. For example, when the mobile terminal 200 is a mobile phone, the telephone number, mail address or the like unique to the mobile phone may be used as the ID information. Furthermore, the ID information also includes ID of terminal information for separately managing each terminal information (message) sent. The “ID of terminal information” is added in a way as to be different for each terminal information. Moreover, to distinguish between the identification information of the mobile terminal 200 and the ID of the terminal information, the ID information of the terminal information is referred to also as a “message ID,” and the ID information of the terminal is referred to also as a “terminal ID.” That is, messages can be distinguished from each other by only the message ID or by the combination of the message ID, the terminal ID and the time information described below. Preferably, the terminal ID is set in advance and is stored in the terminal information storage section 202, and the message ID is added by the terminal information control 201 at the time of message transmission.

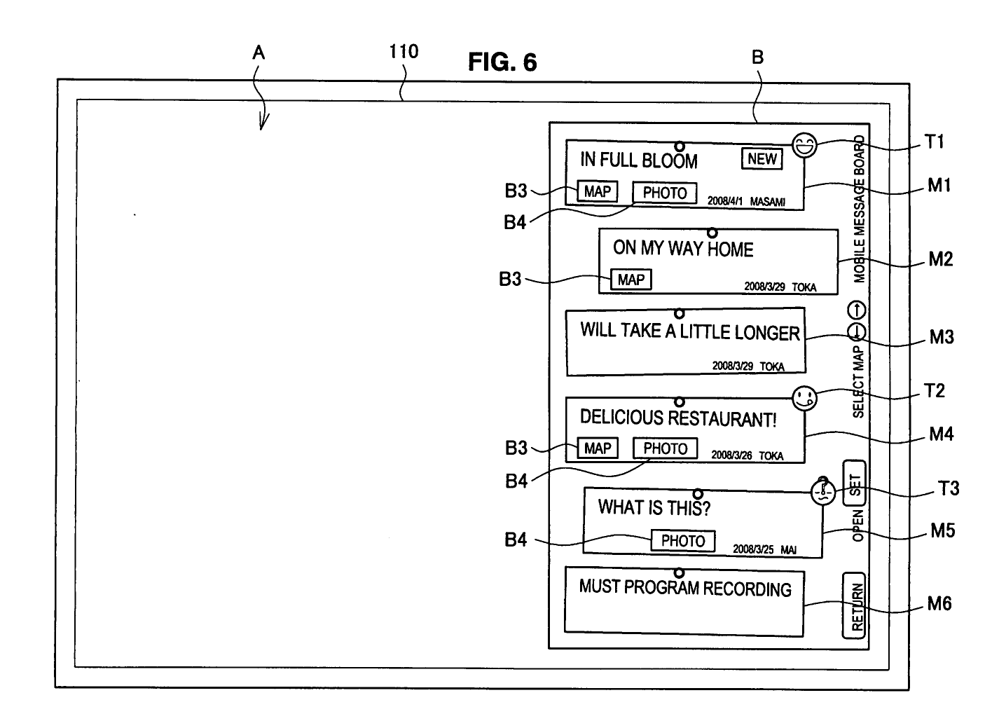

The “text information” is the main information included in a message, and may be generated by the terminal information control section 201 according to an operation by a user, or may be stored in advance in the terminal information storage section 202. The text information may be, for example, information created by a user of the mobile terminal 200 to be sent to a user using the image display device 100 or a user who might use the image display device 100. Furthermore, the text information may also include “setting information” to be used at the time of displaying the message. The setting information is information indicating in what format the message is to be displayed by the display section 110 of the image display device 100. The setting information may be the color of texts or a card at the time of displaying the text information on the display section 110, the type of a mark (tag) to be added to the message, or the like. As will be described later, each message is displayed on the display section 110 of the image display device 100 in relation to each user or the like, and at the time of display, is displayed in a form of a card (a piece of paper) pinned to a message board (see FIG. 6), for example. Accordingly, among the setting information, the color of texts indicates the color of the text information to be described on the card, and the color of a card indicates the color of the card itself. The mark may be, for example, a mark resembling a face expressing thoughts or feelings of a user, impression received by the user, or the like. In addition, for example, the mark may be emoticons, various marks to be used in mobile-phone emails, or the like. Furthermore, the setting information may further include, for example, the color or type of a pin pinning the card, the shape of the card, or the like. Moreover, although the message (terminal information) mainly includes the text information, it may include other terminal content or location information without including the text information. That is, the message preferably includes at least one of the location information described above, the text information and the terminal content described below. Moreover, even if the text information is not included in the message, it is preferable that the setting information is included. In the following, for the sake of the convenience of explanation, explanation will be made assuming that all of the text information, terminal content and location information are included in the message.

The “terminal content” is information indicating content such as an image, a video, music or the like, and is stored in the terminal information storage section 202 in advance. For example, when the mobile terminal 200 is a mobile phone, the present-day mobile phone is provided with a camera and a microphone. Accordingly, the terminal content may be image-captured, shot or recorded in advance by such image-capturing device and sound collecting device, and be stored in the terminal information storage section 202. Furthermore, the terminal content may also be acquired from an information publishing server (not shown) via the network 5 by the mobile terminal 200, and be stored in the terminal information storage section 202. Furthermore, the timing of storing the terminal content may be before or at the time of message transmission by the terminal information control section 201. Moreover, in case the mobile terminal 200 acquires the terminal content at the time of the terminal information control section 201 sending a message, the terminal content does not have to be temporarily stored in the terminal information storage section 202.

An example of the message (terminal information) is shown in the following Table 1. The terminal information control section 201 sends a message as shown in Table 1 to the server 300. Moreover, the terminal information control section 201 may send the message as many times according to an operation by a user.

TABLE 1

| Transmission | Time | 01/25/2008 16:43 |
|---|---|---|
| Information | Location | Latitude 35.618_Longitude |
| ID | Terminal ID | 123-4567-8910 |
| Information | Message ID | 1020 |
| Text Information | | Be home soon. |
| Setting | Text Color | 1 |
| Information | Card Color | 2 |
| | Mark (Tag) | 1 |

| | |
|---|---|
| Terminal Content No. 1 | cherryblossom.jpg |
| Terminal Content No. 2 | cherryblossom.mpg |
| Terminal Content No. 3 | flowerviewing.mp3 |

The terminal information control section 201 generates a message as described above and sends the message to the server 300, and when sending the message, the terminal information control section 201 accesses the server 300 (for example, a dedicated Web page). At the time point of accessing the server 300, the terminal information control section 201 sends to the server 300 at least a part of the information included in the message (terminal information). The information to be sent at the time of access may be the transmission information and the ID information, for example. Then, during the access to the server 300, the terminal information control section 201 generates or acquires the text information, the setting information and the terminal content, and sends the same to the server 300. Moreover, at this time, the terminal information control section 201 may send again the transmission information to the server 300.

At the time of generation, transmission or the like of the above-described message (terminal information) by the terminal information control section 201, the display control section 203 makes the display section 210 display a predetermined image to assist the operation of the mobile terminal 200 by the user. Accordingly, the user operates the mobile terminal 200 while referring to the image displayed on the display section 210, and the mobile terminal 200, for example, generates or sends a message according to the operation.

The display control section 203 makes the display section 210 display together “provision information” sent from the server 300. The provision information is generated by the server 300 or another provision information generation server (not shown) to be provided to the user. The provision information includes information considered to be helpful to the user, depending on each user. The provision information may be, for example, an advertisement or information which has to be notified to the user, and various other types of information may also be used. Moreover, the provision information and generation process thereof will be described along with the server 300.

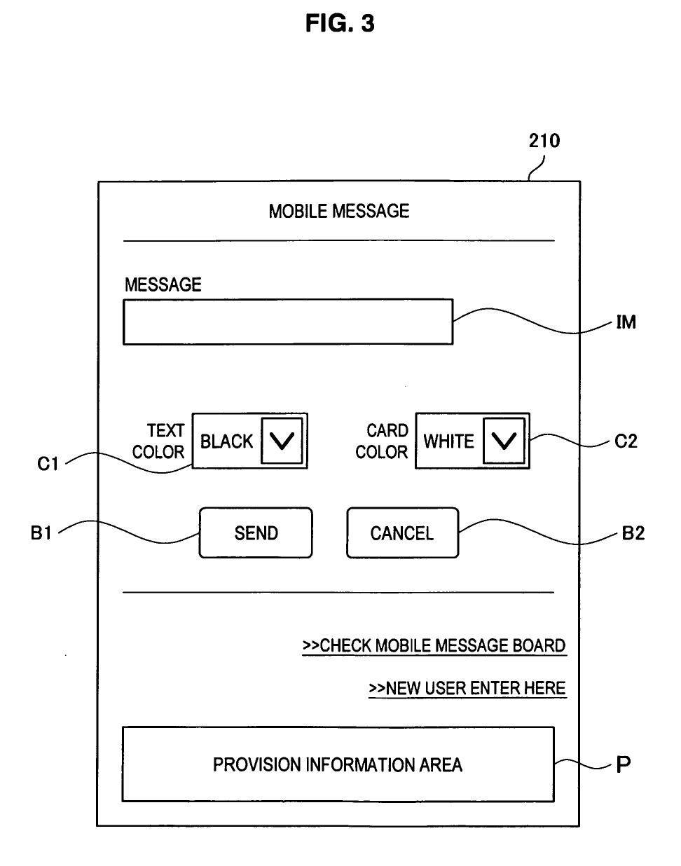

Here, an example of the image that the display control section 203 makes the display section 210 display will be shown in FIG. 3. FIG. 3 is an explanatory diagram showing the example of the image that the mobile terminal 200 according to the present embodiment makes a display screen display.

At the time of generating or sending the message (terminal information), the mobile terminal 200 makes the display screen display an image as shown in FIG. 3. The display screen is provided with a message space IM, and text information according to the operation by a user is inputted to the message space IM. The input is performed using keys (buttons) of a mobile phone. The user of a mobile phone is, in many cases, used to inputting an email or the like by the keys. Accordingly, for example, by inputting text information by using an operation section of the mobile phone in this manner, the operability can be improved compared to when inputting texts by using a remote control of a television, or the like.

Furthermore, an input screen is provided with input sections C1 and C2. The input sections C1 and C2 are pull-down menus. The input section C1 is inputted the color of text. The input section C2 is inputted the color of a card. The color of text may be, for example, black, red, blue, green or yellow, and the color of a card may be, for example, white, pink, light blue, grass green, lemon yellow or orange. The user selects the color of text or the color of a card by operating the input section C1 or C2. Then, in response to the operation, the terminal information control section 201 generates setting information (for example, numerical value) corresponding to the color of text and setting information corresponding to the color of a card. Moreover, although not shown in FIG. 3, other input section similar to the input sections C1 and C2 may be provided on the display screen, for example, and the type of a mark may be inputted by the input section. Moreover, when the mark is a mark resembling a face expressing feelings, the type of a mark may be that expressing, for example, smile, tears, joy, anger, sadness, pleasure, question, agreement, shyness, smirk or puzzlement. Furthermore, another input section (not shown) may be provided on the display screen, and the terminal content may be inputted to the input section. In this case, for example, information specifying the location of the terminal content stored (for example, a uniform resource identifier (URI), a pass, or a file name) is inputted to the input section according to an operation by the user.

Then, when a “Send” button B1 provided on the input screen is selected by an operation by the user, the terminal information control section 201 generates the terminal information (message) based on each piece of information that is set as above, and sends the same to the server 300. On the other hand, when a “Delete” button B2 is selected by an operation by the user, the terminal information control section 201 interrupts, stops or ends the operation.

On the other hand, a provision information area P is further provided on the input screen, and provision information sent from the server 300 is displayed in the provision information area P. Accordingly, the user can refer to the provision information while operating the mobile terminal 200.

### (Server 300)

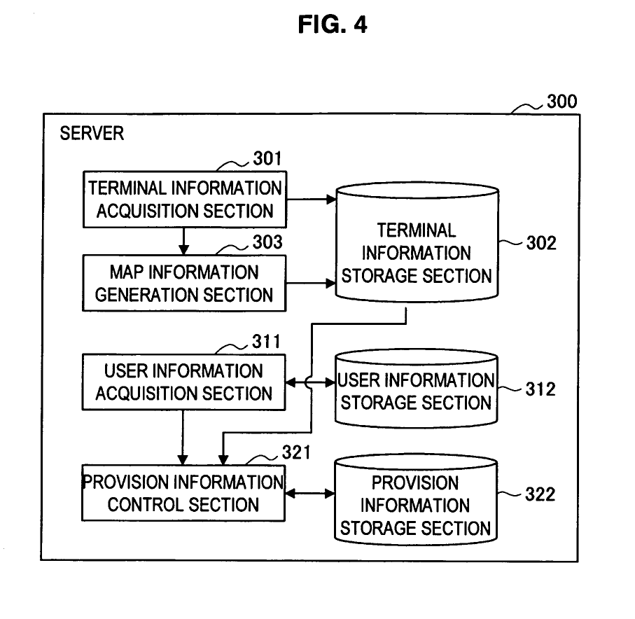

FIG. 4 is an explanatory diagram for describing the server 300 according to an embodiment of the present invention.

As shown in FIG. 4, the server 300 includes a terminal information acquisition section 301, a terminal information storage section 302, a map information generation section 303, a user information acquisition section 311, a user information storage section 312, a provision information control section 321, and a provision information storage section 322.

The terminal information acquisition section 301 acquires a message (terminal information) sent from the mobile terminal 200. Then, the terminal information acquisition section 301 stores the message in the terminal information storage section 302. Moreover, the terminal information acquisition section 301 may newly additionally store the message in the terminal information storage section 302, or depending on the substance of the message, may update a message already stored in the terminal information storage section 302 by addition or alteration.

When location information is included in the message acquired by the terminal information acquisition section 301, the map information generation section 303 generates, based on the location information, map information showing the location according to the location information and its surroundings. The map information generation section 303 has a function of generating the map information from the location information, and may itself generate the map information. Furthermore, the map information generation section 303 may make other map search server (not shown) having the function of generating the map information from the location information generate the map information, and may obtain the map information. The map information generation section 303 adds the generated map information to the message, and stores the same in the terminal information storage section 302.

The user information acquisition section 311 acquires user information from the image display device 100. Then, the user information acquisition section 311 stores the user information in the user information storage section 312.

The “user information” is information indicating an attribute of a user of each mobile terminal 200. The attribute of a user may be the ID information (terminal ID) of the mobile terminal 200 owned by the user, age of the user, sex, position or relationship in a group (for example, father, mother, child, managing director, or general manager), name or nickname of the user, birthday of the user, or the like. The user information is stored in a user information storage section 121 of the image display device 100 in advance by a user who may possibly use the image display device 100 inputting the user information to the image display device 100 in advance. Then, the user information acquisition section 311 acquires the user information from the image display device 100.

An example of the user information is shown in the following Table 2. The user information acquisition section 311 acquires the user information as shown in Table 2 from the image display device 100. Moreover, the user information is set for each mobile terminal 200, and is inputted to the image display device 100 and stored therein in advance.

TABLE 2

| | | |
|---|---|---|
| ID | Terminal ID | 123-4567-8910 |
| Information | | |
| Name | | Ichiro Susuki |
| Nickname | | Toka |
| Relationship | | Father |
| Birthday | | May 31, 1972 |

In a case the terminal information acquisition section 301 acquires a message, the provision information control section 321 sends the provision information to the mobile terminal 200 based on the message and the user information stored in the user information storage section 312. As described above, the provision information will be displayed on the display section 210 of the mobile terminal 200.

The provision information is, as described above, information to be provided to a user, and includes information considered to be helpful to the user, depending on each user. Various types of information, such as an advertisement or information which should be notified to the user, may be included as the provision information. Particularly, the provision information is information relating to each user, and the provision information control section 321 can make the mobile terminal 200 display the provision information relating to each user.

The provision information may be, for example, generated by the provision information control section 321 or by another provision information generation server (not shown). Furthermore, the provision information may be generated in advance and be stored in the provision information storage section 322 in advance, for example.

With regard to the generation process of the provision information, an example where the provision information control section 321 generates the provision information will be described. However, a case of another provision information generation server generating the provision information may be described in the same manner.

The provision information control section 321 acquires the provision information stored in advance in the provision information storage section 322 or the provision information published by another provision information publishing server (not shown), and generates provision information to be sent to the mobile terminal 200. At this time, the provision information control section 321 acquires the provision information by, for example, searching for or extracting the provision information based on a message and the user information. With this method of searching for or extracting the provision information, information suitable and helpful to each user can be, for example, searched for or extracted according to a message and the user information. A large number of variations are conceivable.

For example, the provision information control section 321 can generate provision information according to the relationship or social standing of the user. Since the family structure or the group structure of a user providing the provision information can be grasped from the user information, various aspects of living environment of the user, for example, whether the user has a child, whether the user is living with grandparents, percentage of female in the group, or age group, can be identified or estimated. The provision information control section 321 can narrow down the information suitable for the user based on the living environment. For example, when the provision information is an advertisement, the provision information control section 321 can narrow down the genre of the advertisement, the price range of goods or services being advertised, or the like, and acquire the provision information. For example, the provision information control section 321 may identify, from the user information, the birthday of another user in the group, and provide an advertisement to the user proposing a gift for the user whose birthday is near.

Furthermore, for example, the provision information control section 321 may generate provision information according to the current behavior of the user. The behavior of the user, for example, working (on way to work, working, on way to home), attending school, playing or travelling, can be roughly identified or estimated from the time of day or the location information included in the message. The provision information control section 321 can narrow down information suitable for the user based on the behavior of the user. For example, when the user is on his/her way to home from work, the provision information control section 321 can provide to the user an advertisement linked to an in-train advertisement. Furthermore, for example, when the user is on a trip, the provision information control section 321 may provide to the user information of tourist spots, souvenirs (goods) for a user who is not on the trip or advertisements of stores selling the souvenirs, or the like. Furthermore, the provision information control section 321 can provide, according to the behavior of the user and based on the location of the user as well as the time of day, information relating to stores, transportation facilities, events, or the like, which the user may possibly use or attend.

Furthermore, for example, the provision information control section 321 can also provide information such as news, according to the attribute or the behavior of the user. For example, in case the user is a child, the provision information control section 321 may provide news relating to entrance examinations/examinations, television programs, games, comic books, or the like, and in case the user is a grown-up and on his/her way home, the provision information control section 321 may provide economic news or the like. Moreover, for example, the provision information control section 321 may search for a specific character string in the text information of a message and provide to the user advertisements or information relating to the character strings.

Furthermore, for example, the provision information control section 321 may acquire operation history of the user operating the mobile terminal 200 and provide information which may possibly interest the user according to the history. Moreover, the operation history may be, for example, other home pages that the mobile terminal 200 accessed or goods that are bought through the mobile terminal 200.

As exemplified above, the provision information control section 321 can select information helpful to each user and provide the information to the user, based on the information included in a message and the user information that is registered. Moreover, when sending a message, a user quite likely has his/her attention focused on the display screen to perform operation for generating the message. Accordingly, the provision information control section 321 can provide information relating to each user while increasing the probability of the user viewing the information, compared to other advertisements which may or may not be viewed.

Moreover, the timing of the provision information control section 321 sending the provision information to the mobile terminal 200 is preferably the time point of the mobile terminal 200 accessing the server 300 or immediately thereafter. That is, as described above, when sending the terminal information, the mobile terminal 200 accesses the server 300, and sends to the server 300 at least a part (transmission information and ID information) of the message (terminal information) at the time point of the access. Accordingly, after the terminal information acquisition section 301 acquires the message, the provision information control section 321 generates the provision information and sends the same to the mobile terminal 200. Then, at the time of generating the rest (text information, setting information and terminal content) of the message, the mobile terminal 200 makes the display section 210 display the provision information (see FIG. 3). Moreover, the timing of sending the provision information may be, for example, after the acquisition of the entire message from the mobile terminal 200. In this case, the mobile terminal 200 is made to display the provision information after the transmission of the message.

### (Image Display Device 100)

FIG. 5 is an explanatory diagram for describing the image display device 100 according to an embodiment of the present invention.

As shown in FIG. 5, the image display device 100 includes the display section 110, a content acquisition section 111, a content control section 112, the user information storage section 121, a terminal information acquisition section 131, and a terminal information control section 140.

The content acquisition section 111 acquires image content broadcasted by the broadcasting station 3, image content inputted via an external input line, image content broadcasted by cable, or the like, and outputs the image content to the content control section 112. At this time, according to an operation by the user, the content acquisition section 111 switches the channel (for example, frequency band), the external input line or the like from which the image content is to be acquired, and acquires the image content to be inputted from the switch destination. More concrete example of the content acquisition section 111 will be described below. Specifically, the content acquisition section 111 includes, for example, a tuner, an analog-digital conversion section, a demultiplexer, a decoder (demodulation section), and the like. The content acquisition section 111 tunes the tuner to the frequency band of a channel selected according to an operation by the user, and acquires a broadcast signal in the frequency band by the antenna 2. Furthermore, the content acquisition section 111 converts the acquired broadcast signal to a digital signal by the analog-digital conversion section. The digital signal is split by the demultiplexer into moving or still image data, audio data, attribute information or the like, and is outputted to the content control section 112.

The content control section 112 makes the display section (display screen) 110 display the image content acquired from the content acquisition section 111. As a result, the image display device 100 can display the image content on the display screen.

The user information is stored in advance in the user information storage section 121. The storing may be performed by the image display device 100 according to an operation by the user, or may be performed by the mobile terminal 200 according to an operation by the user. By registering users of a group in advance, an operation according to each user information is enabled.

The terminal information acquisition section 131 acquires a message (terminal information) stored in the terminal information storage section 302 of the server 300. At this time, the terminal information acquisition section 131 may be connected to the server 300 at all times or may poll the server 300 on a regular basis to acquire the message. In case of polling, when a predetermined time has elapsed, the terminal information acquisition section 131 accesses the server 300 and acquires the message stored in the terminal information storage section 302. At this time, for example, the terminal information acquisition section 131 may acquire, among the messages stored in the terminal information storage section 302, a message newly added or a message which is updated since the time point of the previous access. Furthermore, the terminal information acquisition section 131 acquires, with the terminal ID of each user information stored in the user information storage section 121 as a keyword, only a message having the terminal ID. Accordingly, the image display device 100 can acquire only the message sent from a user, who belongs to the group, using the image display device 100. Moreover, such a function of selecting a message may be provided to the server 300.

The terminal information control section 140 makes the display section 110 display the message acquired by the terminal information acquisition section 131. At this time, the terminal information control section 140 makes the display section 110 display the message, based on the user information of the mobile terminal 200 which sent the message. By having the message displayed based on the user information in this manner, each message can be displayed in association with each other.

An example of the image that the terminal information control section 140 makes the display section 110 display will be shown in FIG. 6. FIG. 6 is an explanatory diagram showing an example of the image to be displayed on the display screen by the image display device 100 according to the present embodiment.

Image content is displayed, by a control by the content control section 112, on an image display area A of the display section 110 of the display screen. The terminal information control section 140 makes the display section 110 display a message display area for displaying a message on a part of the display section 110. In FIG. 6, an example is shown where the terminal information control section 140 makes the display section 110 display an image resembling a message board as the message display area. The message display area will also be referred to as a “message board B” herein. Moreover, the message display area is not limited to the message board B, and may be displayed in various formats.

For example, the terminal information control section 140 makes the display section 110 display respective messages acquired by the terminal information acquisition section 131 in a form of cards (pieces of paper) M1 to M6 pinned to the message board B. In accordance with the color of a card indicated in the setting information of a message (for example, 2 is yellow) and the color of texts (for example, 1 is black) indicated in the setting information, the terminal information control section 140 makes the display section 110 display the cards M1 to M6 in the indicated colors, and makes the display section 110 display, on the cards M1 to M6, the text information by the texts in the indicated color. Moreover, for example, the setting information such as the color of a card or the color of texts may be set in the user information instead of being set in a message (terminal information). In this case, the terminal information control section 140 acquires, from the terminal ID of a message, user information associated with the terminal ID. Then, based on the user information, the terminal information control section 140 makes the display section 110 display the respective messages, i.e., the cards M1 to M6. By changing the color of the cards M1 to M6 or the color of texts for each user or each message, the terminal information control section 140 can provide even information which is hard to convey just in texts and with which a user or a message is easy to visually grasp. At this time, the terminal information control section 140 does not make the display section 110 display the cards M1 to M6 in an orderly alignment, but makes the display section 110 display the cards M1 to M6 at somewhat random locations and angles. Furthermore, by having the cards M1 to M6 displayed in this manner, the terminal information control section 140 can make the display section 110 display, along with the message board B resembling a real-life message board, messages in a form more like a real-life message board, and readability of each message can be enhanced.

Furthermore, also in cases other than those described above, the terminal information control section 140 acquires from the terminal ID of a message the user information associated with the terminal ID. Then, the terminal information control section 140 makes the display section 110 display information included in the user information on the cards M1 to M6. Moreover, in FIG. 6, a case is shown where the terminal information control section 140 makes the display section 110 display nicknames of users on the cards M1 to M6 (for example, “Toka,” “Masami,” “Mai”). In addition, for example, by determining from the birthday of a user that the time information of a message indicates the birthday of the user or a day near his/her birthday, the terminal information control section 140 may make the display section 110 display by using texts or a mark that it is his/her birthday. Furthermore, schedule of each user can be registered in the user information in advance, and the behavior of a user may be displayed based on the schedule and the time information or the location information. In this case, the schedule of a user may be acquired as the terminal information from the mobile terminal 200 or may be acquired by the mobile terminal 200 and the image display device 100 synchronizing data in advance. Furthermore, in addition, time alarm information may be included in the user information. Date and time or time is indicated, along with the details of an alarm, in the time alarm information, and when a predetermined condition is not met on the date and time or at the time, the terminal information control section 140 may display on the display section 110 an alarm display showing the details of the alarm. For example, when a curfew is set for a user of the mobile terminal 200 but the user does not get home and operate the image display device 100 by the curfew, the time alarm information may be information which displays on the display screen, as the alarm display, that the user has not returned home and notifies a viewer to that effect. In addition, for example, when a user does not send a message including predetermined location information by a predetermined time, information for notifying to that effect may be used as the time alarm information. In this case, the information may be used to manage the behavior of an employee making rounds, or the behavior of a family member, for example, whether a child attending a school has arrived at the school or a cram school on time.

Furthermore, when information of marks is included in messages, marks corresponding to the information of marks (for example, 1 is a smiley) T1 to T3 are displayed by the terminal information control section 140 by being added to the cards M1 to M6. Accordingly, the terminal information control section 140 can have the state of mind, feelings or the like of a user at the time of sending a message displayed in such a way as to enable easy and intuitive grasp thereof.

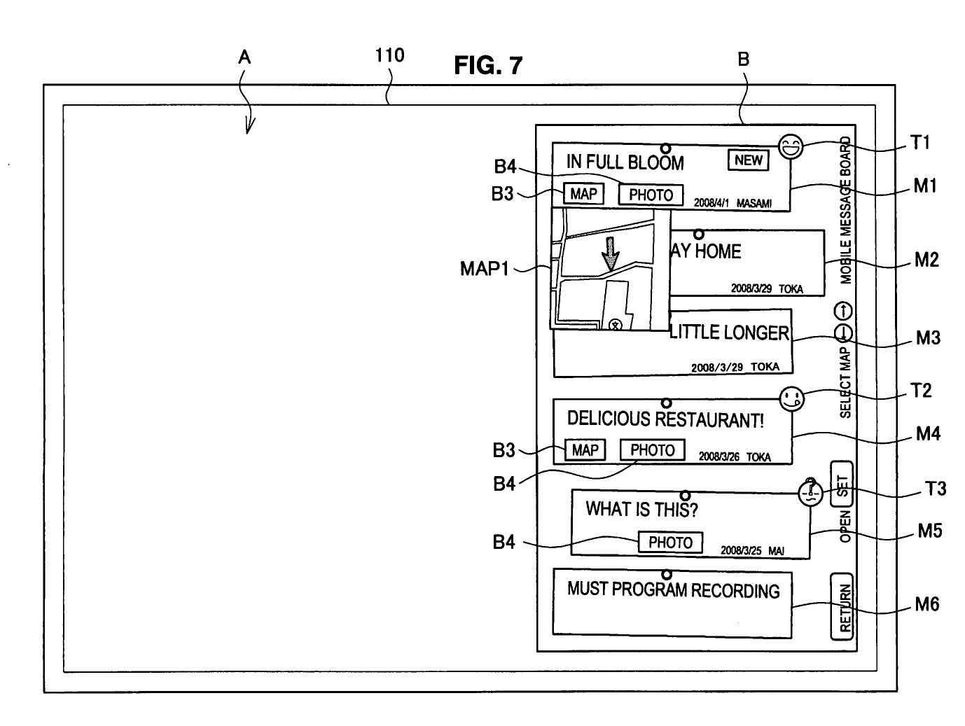

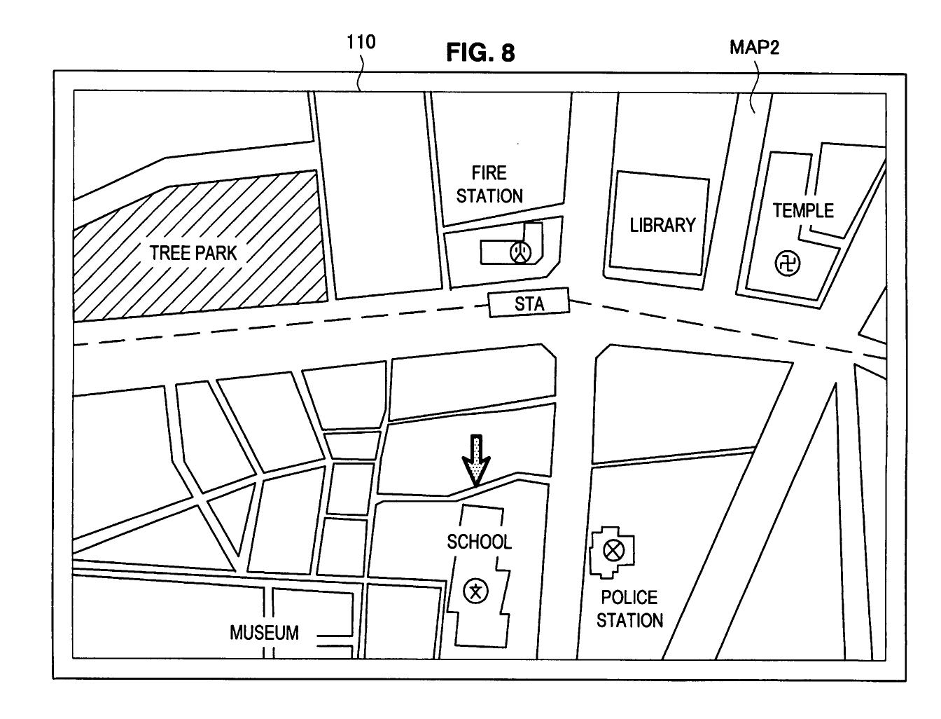

Furthermore, when map information is included in messages, the terminal information control section 140 makes the display section 110 display, on the cards M1 to M6 of the messages, a button B3 for displaying a map. Then, when display of the map is selected by an operation on the remote control 4 by a user (for example, when the button B3 is selected), the terminal information control section 140 makes the display section 110 display a map MAP1 as shown in FIG. 7. Then, when display of the map is further selected by an operation on the remote control 4 by the user, the terminal information control section 140 makes the display section 110 display a map MAP2 (for example, a map showing an enlarged view or a wider area than the map MAP1) indicated in the map information as shown in FIG. 8. Accordingly, the terminal information control section 140 can notify a user viewing the image display device 100 of the location from which each message is sent.

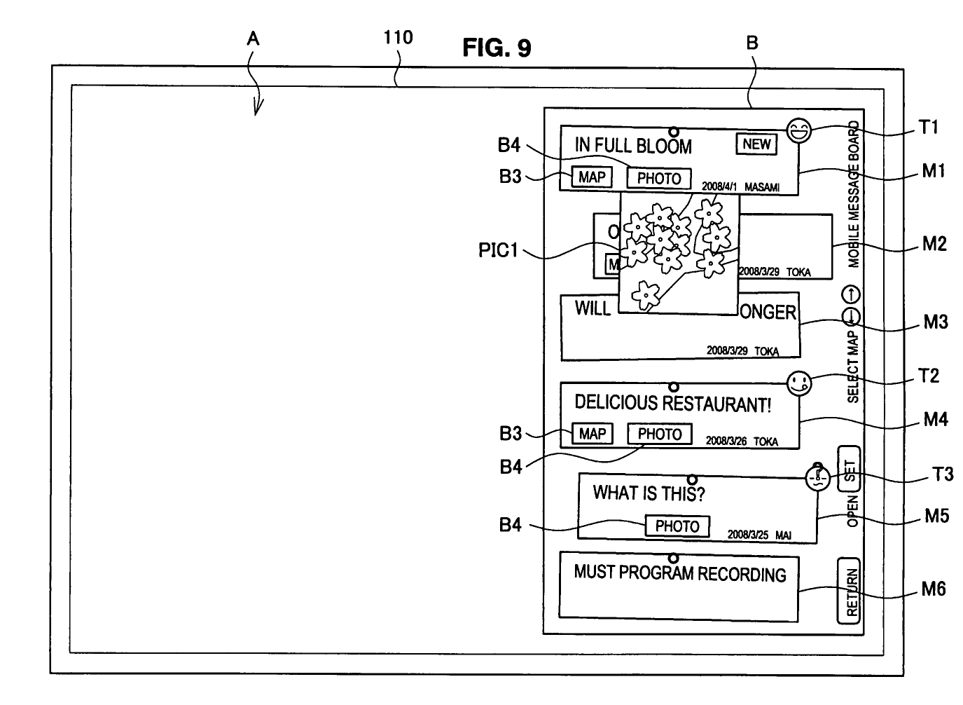

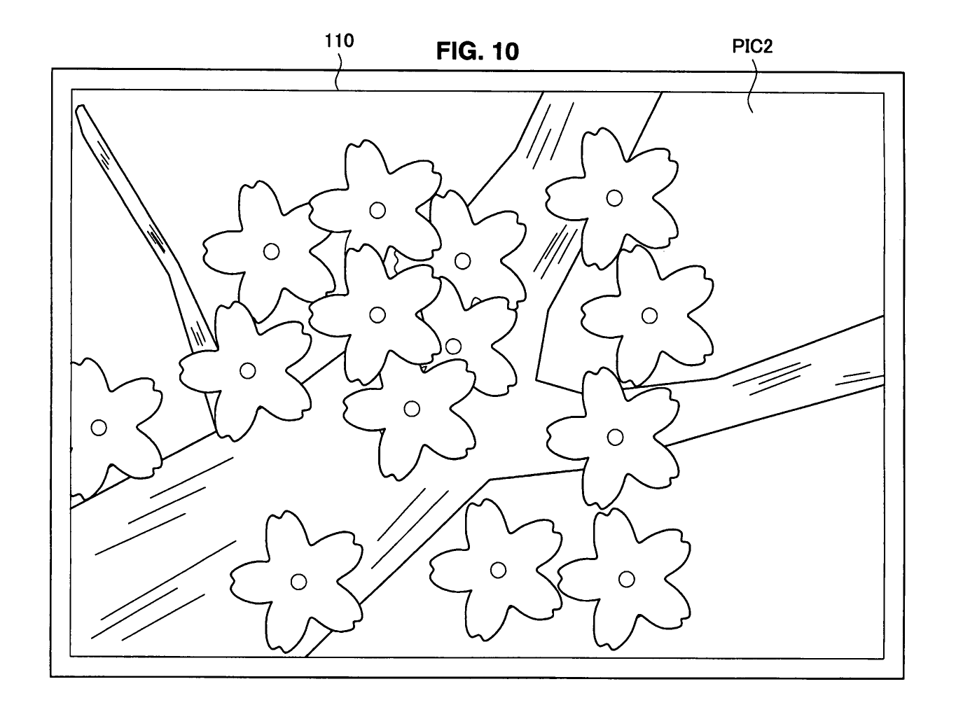

Furthermore, when terminal content is included in messages, the terminal information control section 140 makes the display section 110 display, on the cards M1 to M6 of the messages, a button B4 for displaying the terminal content. Then, when display of the terminal content is selected by an operation on the remote control 4 by a user (for example, when the button B4 is selected), the terminal information control section 140 makes the display section 110 display terminal content PIC1 as shown in FIG. 9. Then, when display of the terminal content is further selected by an operation on the remote control 4 by the user, the terminal information control section 140 makes the display section 110 display terminal content PIC2 (for example, content more enlarged than the terminal content PIC1) as shown in FIG. 10. Moreover, when the terminal content is a moving image or audio and the button B4 is selected, the terminal information control section 140 is made to playback the content. Accordingly, the terminal information control section 140 can make the display section 110 display the terminal content added to each message as well. Thus, not only the text information, but also other contents can be shared.

While having a message displayed on the message board B in this manner, the image display device 100 also has image content displayed on the image display area A other than the message board B. Accordingly, the image display device 100 can not only have one of the message and the image content displayed, but also provide both to a user simultaneously. This makes it further possible to have the message board B displayed on the image display device 100 at all times, for example. Compared to a computer or the like, for example, the image display device 100 is more likely to be shared among a group and more likely to be operated at all times. On the other hand, such an image display device 100 can display the message board B at all times without impairing the fundamental function of displaying image content. Accordingly, according to such a system, the mobile terminal 200, which is highly portable and which is to be owned by each user, generates terminal information (message, information to written on the message board B), and the image display device 100, which is highly public and which performs display at all times, displays the terminal information. Accordingly, information sharing among a group can be effectively promoted by the system.

At the time of having the message board B displayed, the terminal information control section 140 of the image display device 100 can make the display section 110 display a plurality of messages in relation to each other, based on at least either of each message and the user information. Correlation between the plurality of messages may be in various forms. An example of the correlation will be described in the following.

In FIG. 6, for example, the terminal information control section 140 makes the display section 110 display the cards M1 to M6 in the order of arrival of the messages, according to the transmission time of each of the messages. In the case of the example of FIG. 6, for example, when the terminal information acquisition section 131 receives a new message, the terminal information control section 140 makes the display section 110 display the message in the uppermost part. The terminal information control section 140 sequentially lowers the positions of other messages M1 to M5, and also deletes the message M6 which was displayed on the lowermost part from the display section 110. By making the display section 110 display in this manner, the terminal information control section 140 can emphasize a newly arrived message, and at the same time, make the display section 110 display older messages in chronological order. Moreover, the terminal information control section 140 may also make the display section 110 display a message currently not displayed, according to an operation by a user.

Furthermore, as another example of the correlation between the plurality of cards M1 to M6, the terminal information control section 140 may also make the display section 110 collectively display the cards M1 to M6 for each user according to the user information, for example. In this case, each user is assigned an area on the message board B, and the terminal information control section 140 makes the display section 110 display the cards M1 to M6 of each user in the assigned area. When a plurality of messages are sent from a same user, the terminal information control section 140 makes the display section 110 display the cards in the area assigned to the user in an overlapping manner, for example. According to such a display, the terminal information control section 140 can make the display section 110 display the new message from each user at all times.

Furthermore, when displaying information collectively for each user, the terminal information control section 140 can, for example, add messages to each of the cards M1 to M6. That is, when a new message is acquired from a user (mobile terminal 200) same as the user of the already displayed message, the terminal information control section 140 adds the new message on a single card together with the already displayed message and makes the display section 110 display the same. In this example, when text information is sent as one message and terminal content is sent as the next message, for example, the terminal information control section 140 may combine the messages and make the display section 110 display the messages as one card. On the other hand, even in a case of not displaying the messages collectively, a plurality of messages may be displayed on a single card in the same manner by the mobile terminal 200 including, in a message to be generated, information regarding whether a plurality of messages are to be combined or not, for example.

Furthermore, when information is to be displayed collectively for each user, and further, when map information is included in a plurality of messages to be collected, the terminal information control section 140 may generate a single map by combining the plurality of pieces of map information and make the display section 110 display the map, for example. In this case, a plurality of locations from which the messages have been sent are indicated in the map information. Accordingly, the terminal information control section 140 may make the display section 110 display also a track showing how the user of the mobile terminal 200 moved.

In this manner, the terminal information control section 140 may make the display section 110 display a plurality of messages in correlation with each other based on messages and user information. Accordingly, since the image display device 100 can more effectively provide various types of information to a user, the user can use the image display device 100 for various uses.

### Operation of Embodiment

Heretofore, each configuration of the system according to an embodiment of the present invention has been described.

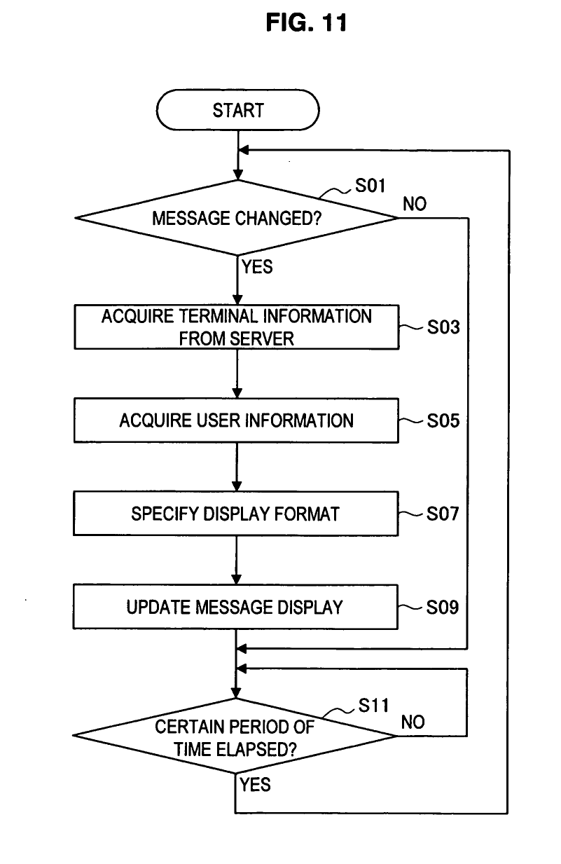

Next, with reference to FIG. 11, an operation of the image display device 100 according to an embodiment of the present invention will be described. FIG. 11 is an explanatory diagram for describing an operation of the image display device 100 according to the present embodiment.

As shown in FIG. 11, first, when the terminal information control section 140 or the like starts an operation while the content acquisition section 111 and the content control section 112 are making the display section 110 display image content (content display step), step S01 is processed. In step S01, the terminal information acquisition section 131 accesses the terminal information storage section 302 of the server 300, and checks whether there is a change in a message (terminal information) or whether there is a new message. When there is a change in a message or when there is a new message, the process proceeds to step S03, and when there is no such message, the process proceeds to step S11.

In a case the process proceeds to step S03 due to a change in a message or a new message, in step S03, the terminal information acquisition section 131 acquires the message from the terminal information storage section 302 of the server 300 (terminal information acquisition step). Then, the process proceeds to step S05.

In step S05, the terminal information control section 140 acquires, from the user information storage section 121, the user information of the mobile terminal 200 from which the message has been sent. Then, the process proceeds to step S07.

In step S07, the terminal information control section 140 specifies display format of the message. As described above, the terminal information control section 140 can make the display section 110 display a message in various formats based on the message and the user information. Specifically, for example, the terminal information control section 140 can add a nickname in the user information to a message, or make the display section 110 display a plurality of messages in correlation with each other. Accordingly, in step S07, the terminal information control section 140 specifies the display format based on the message and the user information. Information for specifying the display format may be pre-set in the image display device 100 itself, be changed in each case, be included in the user information, or be included in setting information or the like of a message sent from the mobile terminal 200. After step S07, the process proceeds to step S09.

In step S09, the terminal information control section 140 makes the display section 110 display a card of the changed or new message in the display format determined in step S07, and updates the message board B (terminal information display step). Then, the process proceeds to step S11.

In step S11, the terminal information acquisition section 131 checks whether a certain period of time has elapsed after the process of step S01. In a case a certain period of time has elapsed, the process is repeated from step S01. On the other hand, in a case a certain period of time has not elapsed, step S11 is repeated until a certain period of time elapses, and the image display device 100 displays, along with the image content, the message board B as well.

### Example of Effect of Embodiment

Heretofore, the system 1, the image display device 100 and the like according to an embodiment of the present invention has been described. According to the system 1, a message (terminal information) can be displayed along with image content, without causing a sense of discomfort, by the image display device 100 which is likely to be shared among a specific group. The message is generated by the mobile terminal 200 which is likely to be owned by each user of the group, and is displayed by the image display device 100, with the user specified, based on the user information of each message. Accordingly, each user can send a message from any place using his/her own mobile terminal 200, and can display the message by the image display device 100 used in common among the group. Accordingly, information sharing among a specific group is promoted, and information can be shared more effectively. For example, each user can display information to be shared with other user while he/she still remembers, and thus a function of a memorandum may be included.

Furthermore, the image display device 100 as described can display a message while displaying image content at all times. The image display device 100 can also update a message as appropriate. Accordingly, a message displayed by the image display device 100 is automatically updated every time the message is displayed. Therefore, a user does not have to continually perform an operation of updating a message, and the operability of a user can be improved.

Moreover, for example, with a message board site on a computer, or the like, information has to be browsed using a computer owned by each user, and usability is poor compared to a real-life message board. Furthermore, with the message board on a computer, whether to access the message board is up to each individual, and information is not effectively shared in the sense that the message board is to be provided to a plurality of users in a specific group. However, according to the system 1 according to the present embodiment, information can be provided in a form more like a real-life message board compared to the message board site or the like, and also the mobile terminal 200 is enabled to write on the message board no matter where the mobile terminal 200 is located as long as it is located within a communicable range. Furthermore, according to the system 1, a message is displayed by the image display device 100 which is, in many cases, operated at all times, and the message is automatically updated. Accordingly, according to the system 1, a plurality of users in a specific group can share information in a more effective and efficient manner. Furthermore, the system 1 is able to improve convenience compared to the message board site on a computer as described above.

Furthermore, according to the system 1, each user can input a message by using the mobile terminal 200 which the user is used to and to which the user can input letters with ease. Accordingly, the operability of a user can be further improved.

Furthermore, according to the system 1, information helpful to a user can be selected and provided to the mobile terminal 200, based on the location, time of the transmission of a message, substance of the message, or the like, as well as based on the user information of the mobile terminal 200 which sent the message. Accordingly, compared to a case where provision information is provided randomly, provision information more helpful to a user can be provided. Also, according to the system 1, since the provision information is displayed on the mobile terminal 200 the user is actually operating, frequency of browsing the provision information can be increased.

Furthermore, a message is acquired by using terminal ID of user information or the like, and thus information sharing between a specific image display device 100 and a specific mobile terminal 200 is enabled, and confidentiality and privacy of each message can be enhanced.

Although a preferred embodiment of the present invention is described in the foregoing with reference to the drawings, the present invention is not limited thereto. It should be understood by those skilled in the art that various modifications, combinations, sub-combinations and alterations may occur depending on design requirements and other factors insofar as they are within the scope of the appended claims or the equivalents thereof.

For example, in the embodiment described above, a case has been described where a message is displayed on the display section 110 of the image display device 100 in a form of the message board B. However, the present invention is not limited to such an example. For example, the message may be displayed on the display section 210 of the mobile terminal 200. In this case, the mobile terminal 200 may display the message board B by including the same structural elements as the user information storage section 121, the terminal information acquisition section 131 and the terminal information control section 140, for example.

Furthermore, in the embodiment described above, a case has been described where a single server 300 includes the terminal information acquisition section 301 and the like along with the provision information control section 321 and the provision information storage section 322. However, the provision information control section 321 and the provision information storage section 322 may be other separate servers (for example, a provision information generation server). In this case, this other server may acquire a message and user information from the server 300, generate provision information from the message and the user information, and send the provision information to the mobile terminal 200.

Furthermore, in the embodiment described above, a case has been described where the server 300 includes the map information generation section 303. However, the map information generation section 303 may be provided in the mobile terminal 200 or in the image display device 100, for example. In case the mobile terminal 200 includes the map information generation section 303, the mobile terminal 200 can generate map information in advance by using location information, and initially add the map information to a message. On the other hand, in case the image display device 100 includes the map information generation section 303, the image display device 100 may generate map information when acquiring a message, based on the location information included in the message, and provide the map information to the terminal information control section 140.

Furthermore, a series of processes described for each embodiment described above may be executed by dedicated hardware, or may be executed by software (application) such as applicast or widget. In case the series of processes are to be executed by software, the series of processes may be realized by a general-purpose or dedicated computer executing a program. The computer may include a central processing unit (CPU), a recording device such as a hard disk drive (HDD), a read only memory (ROM) or a random access memory (RAM), a communication device connected to a network such as a local area network (LAN) or the Internet, an input device such as a remote control, a mouse or a keyboard, a drive for reading from or writing on a removable storage medium or the like such as a magnetic disk, e.g. a flexible disk, an optical disk, e.g. a variety of compact discs (CDs), a magneto optical (MO) disk or a digital versatile disc (DVD), or a semiconductor memory, an output device or the like such as a display section, e.g. a monitor, or an audio output device, e.g. a speaker or a headphone, or the like. The computer may execute the series of processes described above by executing a program stored in the recording device or the removable storage medium or by executing a program acquired via a network.

Moreover, in this specification, steps shown in the flow chart may include not only the processing to be performed chronologically in the order shown, but also the processing that is to be performed in parallel or individually without being performed chronologically. Furthermore, the order of the steps to be performed chronologically may, of course, be changed as appropriate.

What is clamed is:

1. An image display device, comprising:
a content control section for making a display screen display image content;
a terminal information acquisition section for acquiring terminal information sent by a mobile terminal;
a user information storage section in which user information indicating an attribute of a user of the mobile terminal is stored; and
a terminal information control section for making the display screen display the terminal information acquired by the terminal information acquisition section, based on the user information of the mobile terminal that sent the terminal information.

2. The image display device according to claim 1, wherein
when the terminal information acquisition section acquires a plurality of pieces of terminal information sent from one mobile terminal of the user, the terminal information control section makes the display screen display the plurality of pieces of terminal information in association with each other based on the user information stored in the user information storage section.

3. The image display device according to claim 2, wherein
when the terminal information acquisition section acquires new terminal information from the mobile terminal that sent the terminal information already displayed by the display screen, the terminal information control section makes the display screen display the new terminal information additionally to the already displayed terminal information.

4. The image display device according to claim 1, wherein
the terminal information includes at least one of text information inputted to the mobile terminal by the user, location information indicating a location of the mobile terminal and terminal content stored in the mobile terminal, and
the terminal information control section makes the display screen display at least one of the text information, the location information and the terminal content.

5. The image display device according to claim 4, wherein
where the location information is included in the terminal information acquired by the terminal information acquisition section, the terminal information control section makes the display screen display a map showing the location information.

6. The image display device according to claim 5, wherein
when the terminal information acquisition section acquired a plurality of pieces of location information sent from one mobile terminal of the user, the terminal information control section makes the display screen display one map showing the plurality of pieces of location information.

7. The image display device according to claim 1, wherein
the terminal information control section makes the display screen display the terminal information along with the image content displayed by a control by the content control section.

8. A server, comprising:
a terminal information control section for acquiring terminal information sent by a mobile terminal and storing the terminal information in a terminal information storage section;
a user information control section for acquiring user information indicating an attribute of a user of the mobile terminal from a user information storage section of an image display device for displaying image content on a display screen; and
a provision information control section for sending to the mobile terminal, when the terminal information control section acquires the terminal information, provision information to be provided to the user of the mobile terminal that sent the terminal information, based on the terminal information and the user information.

9. A mobile terminal, comprising:
a terminal information control section for sending terminal information to be displayed by a display screen of an image display device for displaying image content on the display screen; and
a display control section for acquiring and making the display screen display provision information to be provided to a user sent from a server based on the terminal information sent by the terminal information control section and user information, indicating an attribute of the user that sent the terminal information, stored in the image display device.

10. An image display method, comprising the steps of:
making a display screen display image content;
acquiring terminal information sent by a mobile terminal; and
making the display screen display the terminal information acquired in the step of acquiring terminal information, based on user information indicating an attribute of a user of the mobile terminal that sent the terminal information.

11. A system, comprising:
a mobile terminal;
a server in which terminal information sent by the mobile terminal is stored; and
an image display device for displaying image content on a display screen; wherein
the image display device includes
a terminal information acquisition section for acquiring the terminal information from the server,
a user information storage section in which user information indicating an attribute of a user of the mobile terminal is stored, and
a terminal information control section for making the display screen display the terminal information acquired by the terminal information acquisition section, based on the user information of the mobile terminal that sent the terminal information.
